(19) United States
(12) Patent Application Publication
(10) Pub. No.: US 2017/0367420 A1
(43) Pub. Date: Dec. 28, 2017

(54) SYSTEM AND GARMENT FOR MINIMIZING CLEAN ENVIRONMENT CONTAMINATION

(71) Applicant: MicronShield LLC, Chesterfield, MO (US)

(72) Inventors: William L. Franzen, JR., Chesterfield, MO (US); Don Newsham, Ellisville, MO (US)

(21) Appl. No.: 15/192,636

(22) Filed: Jun. 24, 2016

(51) Int. Cl. A41D 31/00; A41D 13/02; A41D 13/002; B01D 46/00

(52) U.S. Cl. CPC A41D 31/0011; B01D 46/0041; A41D 13/02; A41D 13/0025; B01D 46/0036; B01D 2275/206; B01D 2279/65

(57) ABSTRACT

Garments and corresponding systems for preventing contamination of a clean environment are provided. The garment is formed, at least in part, of a filter medium such that air within the garment is permitted to pass from within the garment, through the filter medium, and into the surrounding environment while contaminants are retained by the filter medium. The garment may be substantially formed of the filter medium or may include one or more filter panels arranged around a substantially impermeable portion of the garment. The garment may further include a forced air inlet for coupling the garment to a forced air supply such as a powered respirator or an air handler. Forced air may then be supplied into the garment to further facilitate air circulation and filtration.

### BACKGROUND

The field of the invention relates generally to a garment for wearing within a cleanroom or other clean environment, and more particularly to a cleanroom garment that is configured to capture contaminants released by a wearer of the garment such that the cleanroom is not contaminated by the wearer.

Cleanrooms or other clean environments are used in nearly every industry where contaminants can negatively impact manufacturing processes. For example, the pharmaceutical industry has embraced the utilization of cleanrooms to control microbial contamination, thereby improving product quality, product integrity, and consumer safety. The electronics manufacturing industry has also widely adopted cleanrooms to minimize the likelihood that particles may cause defects or otherwise compromise product quality. Silicon wafers used in semiconductor manufacturing, for example, are particularly subject to defects caused by particles coming to rest on their surfaces.

Cleanrooms are generally classified according to an International Organization for Standardization (ISO) standard based upon the maximum number of particulates of a certain size that present within a controlled environment. Proper cleanroom design encompasses the entire air ventilation and distribution system. A key component of cleanrooms designs is the integration of filters, such as high-efficiency particulate air (HEPA) or ultra-low particular air (ULPA) filters, into the ventilation and distribution system of the cleanroom to capture airborne contaminants.

Despite advances in clean environment design, any space where human operators work presents a risk of particulate contamination because humans continuously emit, release, and/or cast off particulate matter and microbiologic contaminants. Such contaminants may include complex mixtures of extremely small organic and inorganic particles and liquid droplets. Particulate matter may be made up of a number of components, including acids, organic chemicals, metals, organic matter (such as bacteria), and soil or dust particles.

To prevent contamination of a cleanroom, workers often wear cleanroom garments designed to prevent substances from being released from the wearer's body into the surrounding environment. Such apparel may include boots, shoes, aprons, beard covers, coveralls, face masks, gloves, hoods, shoe covers, and the like. However, known cleanroom garments have relatively low filtration efficiencies (i.e., the percentage of particles of a certain size effectively captured by a filtration media) and are generally unsuitable for stringent clean environments. In order to address these deficiencies, cleanrooms may be required to employ expensive filtration systems for removing contaminants not captured by these known cleanroom garments. Furthermore, known cleanroom garments tend to be hot and uncomfortable for the wearer, adding to both high operational costs and poor compliance with proper cleanroom technique. Increased heat may also foster bacterial growth, increasing a wearer's bioburden and the subsequent risk of contaminating the cleanroom environment.

In light of the foregoing, there is a need for a comfortable cleanroom garment capable of high filtration efficiency.

### BRIEF DESCRIPTION OF THE DISCLOSURE

In one aspect, a garment for preventing contamination of a clean environment by a wearer of the garment is provided. The garment comprises a garment body defining an internal volume and configured to at least partially encapsulate the wearer, the garment body formed, at least in part, of a filter medium, wherein the filter medium is configured to permit air to pass from the internal volume into the clean environment while substantially retaining one or more contaminants, wherein the filter medium comprises one of a high efficiency particulate air (HEPA) filter medium and an ultra-low particulate air (ULPA) filter medium.

In another aspect, a second garment for preventing contamination of a clean environment by a wearer of the garment is provided. The garment comprises a garment body defining an internal volume and configured to substantially encapsulate the wearer, the garment body formed, at least in part, of a filter medium, wherein the filter medium is configured to permit air to pass from the internal volume into the clean environment while substantially retaining one or more contaminants; and a forced air inlet disposed on the garment body, the forced air inlet configured to be coupled to an external forced air supply and to permit fluid communication between the internal volume and the external forced air supply.

In another aspect, a system for preventing contamination of a clean environment is provided. The system comprises a forced air supply; one or more garments, each garment comprising a garment body defining an internal volume and configured to encapsulate at least a portion of the wearer, the garment body formed, at least in part, of a filter medium, wherein the filter medium is configured to permit air to pass from the internal volume into the clean environment while substantially retaining one or more contaminants, and a forced air inlet disposed on the garment body, the forced air inlet configured to be coupled to the forced air supply and to permit fluid communication between the internal volume and the forced air supply; and a conduit coupling the forced air supply to the forced air inlet.

### BRIEF DESCRIPTION OF THE DRAWINGS

FIG. 1 is a schematic drawing of a clean environment including a garment according to a first embodiment.

FIGS. 2A and 2B are schematic drawings of a clean environment including a garment according to a second embodiment.

FIG. 3 is a schematic drawing of a clean environment system including multiple garments according to the first and second embodiments.

FIG. 4 is a flow chart describing a method for preventing contamination of a clean environment.

### DETAILED DESCRIPTION OF THE DISCLOSURE

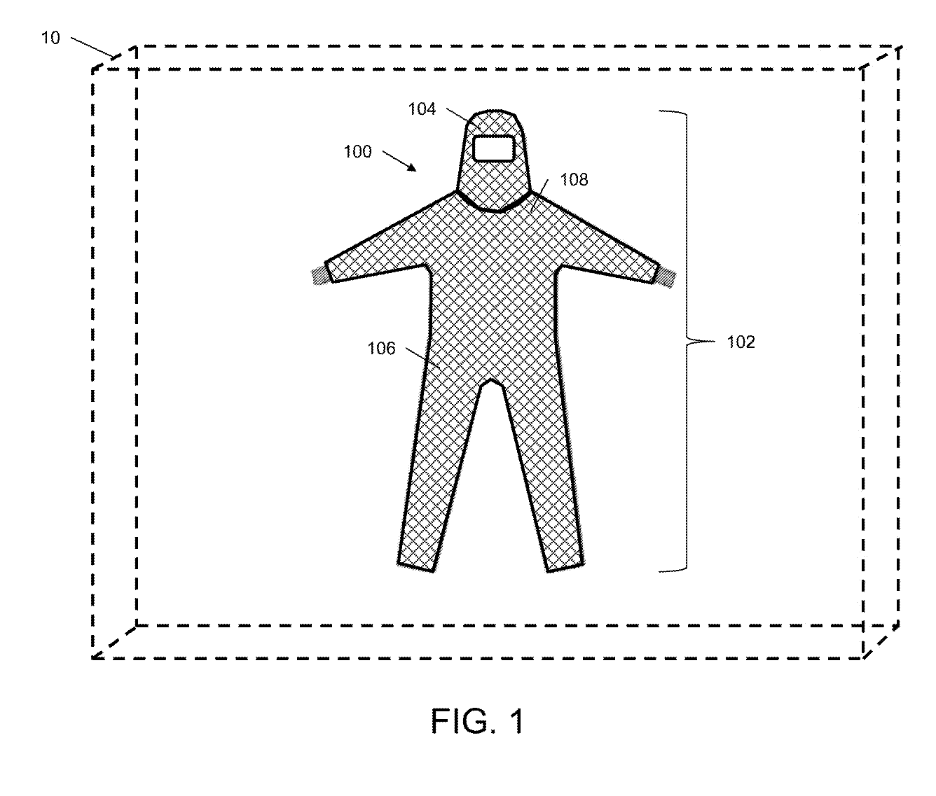

FIG. 1 depicts a clean environment 10 including a garment 100 according to a first embodiment of the present disclosure.

For purposes of this disclosure, the terms “cleanroom” and “clean environment” broadly refer to any area that is required to meet a certain level of cleanliness or to include no more than a certain level of contaminants within the area.

The term “contaminants” is used herein to refer generally to any matter that is undesirable within a cleanroom environment. The term “contaminant” encompasses both hazardous and non-hazardous matter. Example contaminants include, but are not limited to, particulate matter, microbiological contaminants such as bacteria, organic particles, inorganic particles, liquid droplets, acids, organic chemicals, metals, soil, dust, or any combination thereof.

Garment 100 includes a garment body 102 configured to encapsulate at least a portion of a wearer of garment 100. For example, garment body 102 includes a hood 104 and bodysuit 106. Garment body 102 generally defines an inner volume and encapsulates at least a portion of a wearer of garment 100. In certain embodiments, garment body 102 may further include or be configured to attach to gloves, boots, and other garments. Garment body 102 generally encapsulates a wearer's body and head; however in certain embodiments, garments according to this disclosure may encapsulate less of a wearer than garment 100. For example, garments according to this disclosure may be designed to encapsulate only a portion of the wearer's body, such as the wearer's upper torso, or may encapsulate only the wearer's extremities, such as the wearer's arms, hands, feet, legs, and/or head. In certain embodiments, garments according to this disclosure may be configured to encapsulate a substantial majority of the wearer. For example, garment body 102 may be configured to encapsulate more than 50% of a wearer's body, between 75% and 90% of a wearer's body, or more than 95% of a wearer's body.

Garment body 102 is substantially formed of a filter media 108 that permits airflow from the inner volume of garment body 102 into clean environment 10. For example, garment body 102 may be formed of over 90% filter media. As air flows from the inner volume of garment body 102 into the clean environment, filter media 108 retains contaminants within the inner volume of garment body 102 from passing into clean environment 10. In addition to removing contaminants, filter media 108 may also permit air to flow through garment body 102. Such air circulation within garment body 102 generally reduces heat and improves wearer comfort.

In certain embodiments, filter media 108 may be a high efficiency particulate air (HEPA) filter material. Specifically, filter media 108 is selected to meet the HEPA standard by removing at least 99.97% of particles having a size of 0.3 μm. In other embodiments, filter media 108 may be an ultra-low particular air (ULPA), i.e., a filter media capable of removing 99.9995% of dust, pollen, mold, bacteria and other airborne particles with a size of 0.1 μm or larger. Suitable filter media may include, but are not limited to, polyester, fiberglass, foam, paper, and other synthetic and natural materials.

Filter media 108 may include one or more sorbent materials, i.e., absorbents and adsorbents, for capturing organic vapors, acid gases, liquids, and other compounds. For example, filter media 108 may include one or more oxygen-based compounds (such as silica gel and zeolites), carbon-based compounds (such as activated carbon and graphite), or polymer-based compounds having sorbent properties. In certain embodiments, filter media 108 may be composed of a filtration material having sorbent properties. In other embodiments, filter media 108 may be constructed of multiple layers, with one or more of the layers composed of a first material primarily being directed to filtration of contaminants and one or more other layers composed of a sorbent material.

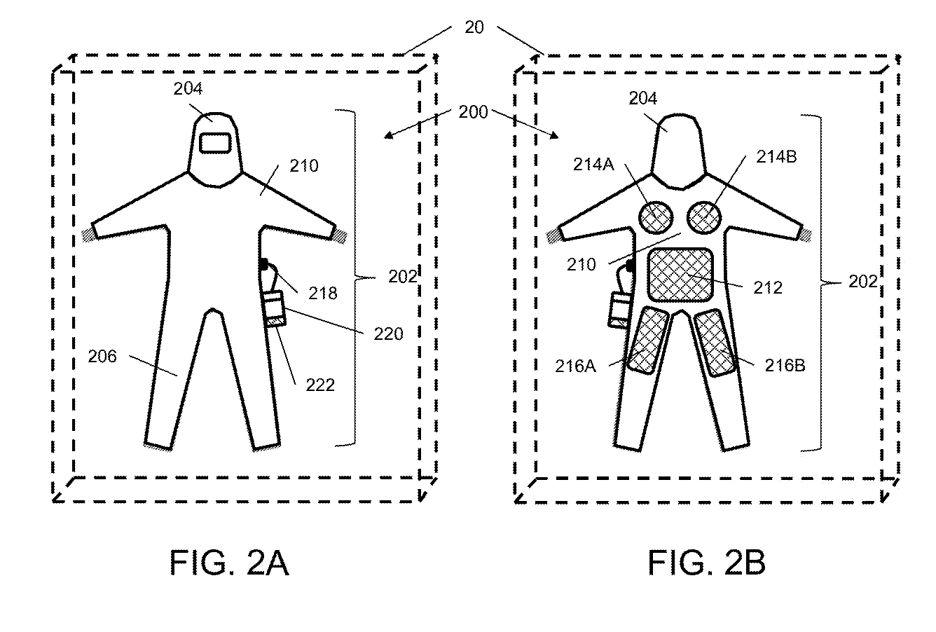

FIGS. 2A and 2B depicts front and rear views, respectively, of a second embodiment of a garment 200 according to this disclosure. Garment 200 is depicted within a clean environment 20. Garment 200 includes a garment body 202 including a hood 204 and bodysuit 206.

Garment body 202 generally comprises a first portion 210 formed of a material that is substantially impermeable to air and contaminants. To permit filtration and circulation of air, garment body 202 includes several filter panels. For example, garment body 202 includes a lumbar filter panel 212, a pair of upper thoracic filter panels 214A, 214B, and a pair of posterior thigh filter panels 216A, 216B, each of which may be formed of a suitable filter media.

In certain embodiments, filter panels may be placed primarily on the back of garment 200. By doing so, the likelihood that contaminants not captured by the filter panels will contaminate items or manufacturing processes being worked on by a wearer of garment 200 may be reduced. Nevertheless, the number and placement of filter panels depicted in FIG. 2 is intended only as an example. In other embodiments, more or fewer filter panels may be disposed on garment body 202 and may be positioned in other locations. For example, in certain embodiments, an upper half of garment body 202 corresponding to a wearer's torso may be formed of a filter media while a lower half corresponding to a wearer's legs may be formed of an impermeable material. In certain embodiments, filter panels may also be positioned in areas of garment 200 based on the likelihood that contaminants will originate from body parts of the wearer or that such body parts may require increased air flow to promote cooling. For example, garments according to this disclosure may generally avoid placement of filter panels near the face, hair, mouth, arm pits, and other areas that are likely to originate contaminants.

Garments according to this disclosure may also be configured to be attached to a forced air supply. For example, garment 200 includes a forced air inlet 218 configured to be coupled to a powered air purifying respirator (PAPR) 220. In certain embodiments, forced air inlet 218 may be further configured to be coupled to other forced air supplies, such as a centralized forced air supply system. During use, PAPR 220 (or another forced air supply) provides forced air into garment body 202, increasing air pressure within garment body 202 and creating a heightened pressure differential between the inner volume of garment body 202 and clean environment 20. By doing so, the rates of air circulation within garment body 202 and filtration of air exiting garment body 202 through the filter panels may be increased as compared to an embodiment in which forced air is not supplied into garment body 202. In other embodiments, forced air inlet 218 may be configured to attach to a central forced air supply. For example, forced air inlet 218 may connect via a tether or other conduit to a forced air supply header that is fed by the central forced air supply.

Forced air supplies for use with garments according to this disclosure may include a forced air intake filter. For example, PAPR 220 includes forced air intake filter 222. In embodiments in which garment 200 is supplied forced air from a central forced air supply, the central air supply system may similarly include one or more forced air intake filters. Forced air intake filter 222 may include one or more sorbent materials for capturing organic vapors, acid gases, liquids, and other compounds from air as it is drawn into and pressurized by PAPR 220. For example, forced air intake filter 222 may include one or more oxygen-based compounds (such as silica gel and zeolites), carbon-based compounds (such as activated carbon and graphite), or polymer-based compounds having sorbent properties. Forced air intake filter 222 is preferably a disposable filter, such as an insert or cartridge, such that forced air intake filter 222 may be replaced when depleted.

In certain embodiments, filter panels, such as lumbar filter panel 212, thoracic filter panels 214A, 214B, and thigh filter panels 216A, 216B, may be permanently attached to garment body 202. In other embodiments, one or more filter panels may be configured to be selectively removable from garment body 202 such that the filter panels may be replaced. Replacement of filter panels may be performed for various reasons, including but not limited to, repairing a damaged filter panel, replacing a depleted filter panel with a fresh filter panel, or changing a filter panel of a first type (e.g., having a first filtration efficiency and/or sorbent properties) with a filter panel of a second type.

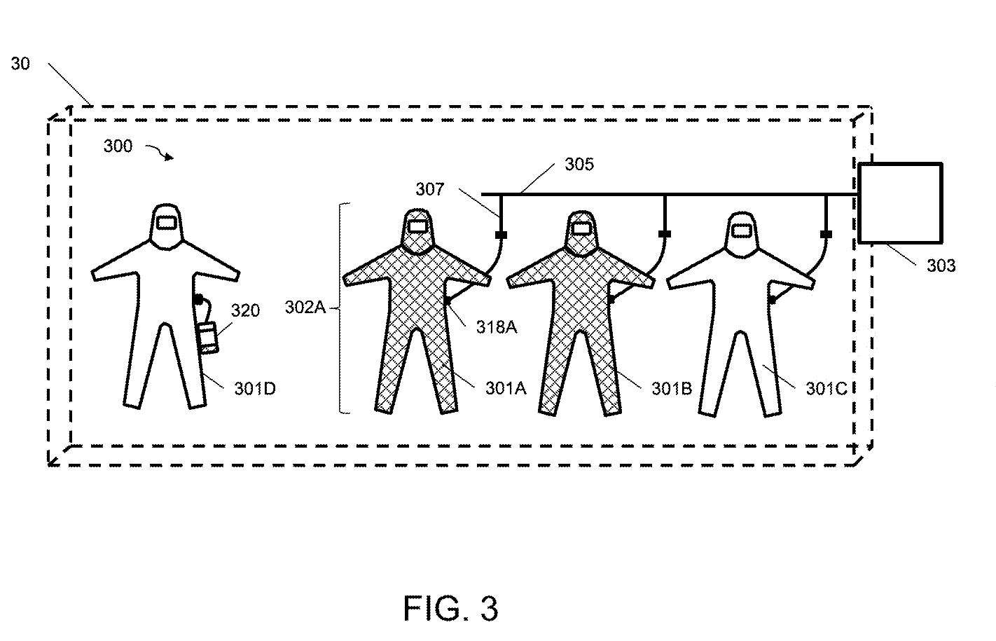

FIG. 3 depicts a clean environment 30 including a clean environment garment system 300 according to an embodiment of the present disclosure.

Clean environment garment system 300 includes multiple cleanroom garments 301A, 301B, 301C, and 301D in a clean environment 30. Embodiments of a clean environment garment system according to this disclosure may include more or fewer cleanroom garments than depicted. Further, while clean environment 30 is generally depicted in the embodiment of FIG. 3 as being a single room, clean environment garment systems in accordance with this disclosure may be configured to prevent contamination in clean environments encompassing multiple distinct rooms or areas.

As depicted in FIG. 3, garments 301A and 301B are substantially similar. As a result, the following description of garment 301A is generally applicable to garment 301B as well. Garment 301A includes a garment body 302A configured to encapsulate at least a portion of a wearer of garment 301A. Garment body 302A is substantially formed of a filter media that permits airflow from the inner volume of garment body 302A into clean environment 30. Garment body 302A further includes a forced air inlet 318A. A forced air supply 303 provides forced air to a header 305 and to forced air inlet 318A via a conduit 307. As depicted, forced air supply 303 may similarly provide forced air to each of garments 301B and 301C.

Individual garments in clean environment garment system 300 may vary. For example, garment 301C is substantially similar to garment 200 depicted in FIGS. 2A and 2B. Specifically, unlike garments 301A and 301B which are substantially formed of a filter media, garment 301C is substantially formed of an impermeable material and includes a series of filter portals located on its back (not depicted).

The method of providing forced air to each garment in clean environment garment system 300 may also vary. For example, each of garments 301A, 301B, and 301C are configured to receive forced air from forced air supply 303 via header 305. In contrast, garment 301D includes a PAPR 320 for providing a personal supply of forced air.

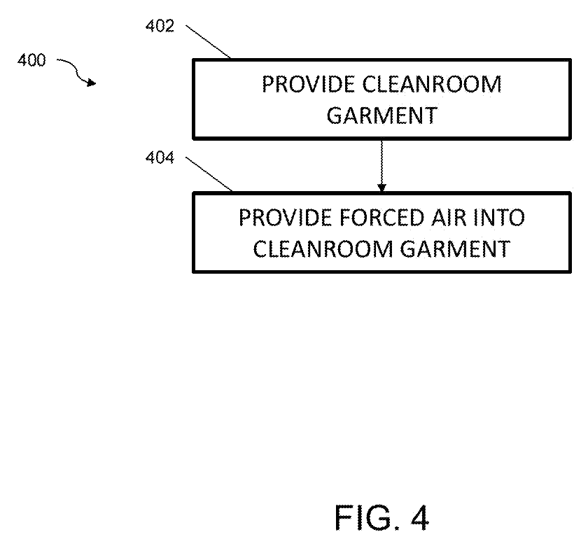

FIG. 4 depicts a method 400 for preventing contamination of a clean environment. At step 402, at least one garment, as previously discussed in this disclosure, is provided.

The garment may generally include a garment body defining an internal volume and may encapsulate at least a portion of a wearer. At least a portion of the garment body includes a filter medium configured to permit air to pass from the internal volume of the garment body into the clean environment while substantially retaining one or more contaminants.

The garment may also include a forced air inlet that permits forced air to be introduced into the internal volume. Accordingly, at step 404, forced air may be provided though the forced air inlet into the garment. By doing so, air pressure within the garment may be increased to create a pressure differential between the inner volume of the garment and the clean environment. Such a pressure differential generally increases the rates at which air is passed from the internal volume of the garment body into the clean environment and at which contaminants are captured by the filter medium.

### Additional Considerations

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. §112(f) unless traditional means-plus-function language is expressly recited, such as “means for” or “step for” language being expressly recited in the claim(s).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A garment for preventing contamination of a clean environment by a wearer of the garment, the garment comprising:
a garment body defining an internal volume and configured to at least partially encapsulate the wearer, the garment body formed, at least in part, of a filter medium, wherein the filter medium is configured to permit air to pass from the internal volume into the clean environment while substantially retaining one or more contaminants, wherein the filter medium comprises one of a high efficiency particulate air (HEPA) filter medium and an ultra-low particulate air (ULPA) filter medium.

2. The garment of claim 1, wherein the garment body is substantially formed of the filter medium.

3. The garment of claim 1, wherein the garment body comprises:
a first garment portion formed of a first material, wherein the first material is substantially impermeable to air and the one or more contaminants, and
a second garment portion formed of the filter medium.

4. The garment of claim 4, wherein the second garment portion is a filter panel configured to be selectively attached to the garment body.

5. The garment of claim 1 further comprising:
a forced air inlet disposed on the garment body, the forced air inlet configured to be coupled to an external forced air supply and to permit fluid communication between the internal volume and the external forced air supply.

6. The garment of claim 5, wherein the external forced air supply is one of a positive air pressure respirator and a central air supply.

7. The garment of claim 1, wherein the garment body is configured to encapsulate a substantial majority of the wearer.

8. A garment for preventing contamination of a clean environment by a wearer of the garment, the garment comprising:
a garment body defining an internal volume and configured to substantially encapsulate the wearer, the garment body formed, at least in part, of a filter medium, wherein the filter medium is configured to permit air to pass from the internal volume into the clean environment while substantially retaining one or more contaminants; and
a forced air inlet disposed on the garment body, the forced air inlet configured to be coupled to an external forced air supply and to permit fluid communication between the internal volume and the external forced air supply.

9. The garment of claim 8, wherein the garment body is substantially formed of the filter medium.

10. The garment of claim 8, wherein the garment body comprises:
a first garment portion formed of a first material, wherein the first material is substantially impermeable to air and the one or more contaminants, and a second garment portion formed of the filter medium.

11. The garment of claim 10, wherein the second garment portion is a filter panel configured to be selectively attached to the garment body.

12. The garment of claim 8, wherein the external forced air supply is one of a positive air pressure respirator and a central air supply.

13. The garment of claim 8, wherein the garment body is configured to encapsulate a substantial majority of the wearer.

14. A system for preventing contamination of clean environments by one or more workers, the system comprising
a forced air supply;
one or more garments, each garment comprising:
a garment body defining an internal volume and configured to encapsulate at least a portion of a wearer of the garment, the garment body formed, at least in part, of a filter medium, wherein the filter medium is configured to permit air to pass from the internal volume into the clean environment while substantially retaining one or more contaminants; and
a forced air inlet disposed on the garment body, the forced air inlet configured to be coupled to the forced air supply and to permit fluid communication between the internal volume and the forced air supply; and
a conduit coupling the forced air supply to the forced air inlet.

15. The system of claim 14, wherein the filter medium is one of a high efficiency particulate air (HEPA) filter material and an ultra-low particular air (ULPA) filter material.

16. The system of claim 14, wherein the garment body is substantially formed of the filter medium.

17. The system of claim 14, wherein the garment body comprises
a first garment portion formed of a first material, wherein the first material is substantially impermeable to air and the one or more contaminants, and
a second garment portion formed of the filter medium.

18. The system of claim 17, wherein the second garment portion is a filter panel configured to be selectively attached to the garment body.

19. The system of claim 14, wherein the forced air supply further comprises an intake filter comprising a sorbent material.

20. The system of claim 14, wherein the garment body is configured to encapsulate a substantial majority of the wearer.
